(19) United States
(12) Patent Application Publication
(10) Pub. No.: US 2022/0051587 A1
(43) Pub. Date: Feb. 17, 2022

(54) MATH GAME

(71) Applicant: Mesa-Davis Enterprises, LLC, Lenoir, NC (US)

(72) Inventors: Mario Mesa, New Rochelle, NY (US); Ricardo Mesa, Hudson, NC (US); Freddie Davis, Lenoir, NC (US); Emanuel Mesa, Hudson, NC (US)

(73) Assignee: Mesa-Davis Enterprises, LLC, Lenoir, NC (US)

(21) Appl. No.: 17/363,464

(22) Filed: Jun. 30, 2021

Related U.S. Application Data
(60) Provisional application No. 63/066,502, filed on Aug. 17, 2020.

(51) Int. Cl. G09B 19/02; G09B 1/34

(52) U.S. Cl. CPC G09B 19/02; G09B 1/34

(57) ABSTRACT

A math game using a deck of playing cards and a set of randomly generated numbers. In one embodiment, a method of playing includes dealing each player a set of cards from a deck of cards. Each card from the deck is marked with either a numerical operand or an arithmetic operator as indicia. Players alternate turns by rolling a set of dice to generate a set of numbers. During each turn, each player discards one or more cards among the player's set of cards by placing the one or more cards onto a discard pile corresponding to an outcome of a mathematical operation performed on the set of numbers.

### RELATED APPLICATION

The following application claims priority to U.S. Provisional No. 63/066,502, filed Aug. 17, 2020, the disclosure of which is incorporated by reference in its entirety.

### FIELD OF THE INVENTION

The present invention relates to a game, and in particular, an educational game for arithmetic.

### BACKGROUND

Games provide an entertaining way for players to pass time. They may be played individually, cooperatively or competitively with others. Games have been created in many different formats over the years, including as tabletop games, card games, video games, sporting games, conversation games, etc. Many sub-categories and genres of these exist with various rulesets and designs that are tailored to specific interests. One genre appealing to parents and caretakers are educational games, which enable players to learn and play at the same time. However, games in this genre may suffer various drawbacks that limit their value. For example, the game may be too challenging and/or complicated to play. Other games may be considered too educational with little entertainment to sustain the interest of its players or entice people to play.

Thus, what is desired is a game that provides educational value while at the same time remaining fun and simple to play for all ages.

### SUMMARY

To this end, the present invention provides an educational game for improving cognitive abilities and mathematical skill. The educational game described herein is a useful educational tool for children learning arithmetic, but also provides benefits for individuals of all ages including increasing the speed of problem-solving.

Accordingly, one aspect of the present invention is directed to a method of playing a math game. In one embodiment, each player is dealt a set of cards from a deck of cards. Each card from the deck is marked with either a numerical operand or an arithmetic operator as indicia. Players alternate turns by rolling a set of dice to generate a set of numbers. During each turn, each player discards one or more cards among the player's set of cards by placing the one or more cards onto a discard pile corresponding to an outcome of a mathematical operation performed on the set of numbers.

Another aspect is directed to a deck of playing cards. The deck includes a first group of cards each having a numerical operand as indicia and a second group of cards each having an arithmetic operator as indicia. The first group of cards and the second group of cards are shuffled together and three or more cards from a set of cards dealt from the deck are intended to be combined to form a mathematical expression. Another aspect is directed to a math game using the deck of playing cards in combination with one or more dice, wherein each die comprises ten faces with each face assigned a unique cardinal number ranging from zero to nine.

These and other aspects will become apparent to those skilled in the art after a reading of the following description of the embodiments when considered with the drawings.

### BRIEF DESCRIPTION OF THE DRAWINGS

FIG. 1 is a plan view of a deck of cards according to one embodiment;

FIG. 2A is a top view of a die according to one embodiment;

FIG. 2B is a front elevation view of the die shown in FIG. 2A;

FIG. 2C is a right side elevation view of the die shown in FIG. 2A;

FIG. 2D is a left side elevation view of the die shown in FIG. 2A;

FIG. 2E is a rear elevation view of the die shown in FIG. 2A;

FIG. 2F is a bottom elevation view of the die shown in FIG. 2A;

FIG. 2G is a front perspective view of the die shown in FIG. 2A; and

FIG. 3 is a board according to one embodiment.

### DETAILED DESCRIPTION OF THE EMBODIMENTS

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

All patents, patent applications and publications referred to herein are incorporated by reference in their entirety. In case of a conflict in terminology, the present specification is controlling.

In accordance with one aspect of the present invention, a method for playing a math game is provided. The math game may be played with one or more players. In some embodiments, the game is played by initially dealing each player a set of cards from a shuffled deck of cards. Each card from the deck may be marked with either a numerical operand or an arithmetic operator as indicia. In some embodiments, each card with a numerical operand in the deck may be marked with a single digit ranging from “0” to “9”. In some embodiments, two or more cards each marked with a single digit may be combined to form a multi-digit numerical operand. For example, the player may place a first card marked with a “2” and a second card marked with a “4” to form the numerical operand “24”. In some embodiments, each card marked with an arithmetic operator may be marked with an addition operator, a subtraction operator, a multiplication operator or a division operator. Alternative embodiments may include additional arithmetic operators other than those listed (e.g., exponential and root functions).

Each player alternates turns by rolling a set of dice to generate a set of numbers. During each turn, each player discards one or more cards belonging to that player's set of cards by placing one cards onto a discard pile. A player places cards that correspond to possible outcomes of a mathematical operation performed on the set of numbers. The player may place a single card marked with a numerical operand that is equal to an outcome. In some embodiments, the player may place two or more cards each marked with a numerical operand that is equal to an outcome. Alternatively, the player may combine three or more cards to form a mathematical expression whose solution is equivalent to an outcome.

In one embodiment, the deck of cards may comprise a first set of cards each labeled with a single digit selected from the range of 0 to 9 and a second set of cards labeled with an addition, subtraction, multiplication or division operator. All cards in the deck are shuffled together and dealt to n players. Each player takes turn rolling a set of dice. For instance, during one turn a player rolls a first die that lands on a “4” and a second die that lands on a “6”. The possible outcomes for the set of numbers are provided in Table 1. In this particular embodiment, only outcomes that are positive whole numbers are possible to solve using the cards on-hand. Players then discard their cards on-hand by placing one or more cards that correspond to a possible outcome into a discard pile. Cards that are not placed in the discard pile remain in the player's hand for the next turn.

Table 2 lists various possible card combinations based on the deck of cards in this particular example. If the “4” and “6” from the set of numbers are added together, then the outcome is a sum of 10. Thus, the player may form a mathematical expression whose solution is equal to 10. One possible expression is 7+3. Therefore, a player may place a first card marked as “7”, a second card marked as “3” and a third card marked with the addition operator “+” into the discard pile. Alternatively, the player may place a first card “1” and a second card “0” forming the number “10” onto the discard pile. Other possible expressions and outcomes are listed in Table 2. The player is not limited to a single card or mathematical expression, and may discard multiple cards equal to the outcome or forming a mathematical expression whose solution is equal to the outcome. Similarly, the player may not be limited to a single outcome and may place cards that correspond to different outcomes. For example, the player may discard a first set of cards forming a mathematical expression whose solution equals the sum of the set of numbers and a second set of cards forming a mathematical expression whose solution is equal to the product of the set of numbers.

TABLE 1
Example of Possible Outcomes for Mathematical Operations
Performed on a Set of Dice Landing on a “4” and a “6”

| | | | | | | |
|---|---|---|---|---|---|---|
| Operation and | 4 + 6 = | 6 − 4 = | 4 − 6 = | 6 × 4 = | 6 ÷ 4 = | 4 ÷ 6 = |
| Outcome | 10 | 2 | −2 | 24 | 1.5 | 0.667 |

TABLE 2
Possible Cards Corresponding to Outcomes for Mathematical
Operations Performed on a Set of Dice Landing on a “4” and a “6”

| Operation | + | − | × | ÷ |
|---|---|---|---|---|
| Outcome | 10 | 2 | 24 | N/A |
| Possible Card | 3 + 7 | 1 + 1 | 8 × 3 | |
| Combinations | 5 + 5 | 4 ÷ 2 | 6 × 4 | |
| | 9 + 1 | 8 − 6 | 6 × 3 + 6 | |
| | 2 × 5 | 2 × 1 | | |
| | 6 + 4 | 1 + 3 − 2 | | |

The number of cards dealt may vary. For example, players may be initially dealt a set number of cards. Once the cards a player has on-hand are all discarded, the player may draw another set of cards from the deck. For instance, players may be dealt seven cards at the beginning of the game and draw another seven cards when the initial seven cards have been discarded. In another example, all cards from the deck are evenly distributed to all players at the beginning of the game.

In some embodiments, the game ends when all cards from the deck have been discarded. In other embodiments, the game may end when a player discards a specified number of cards. In other embodiments, a set number of turns is designated at the beginning.

The game may be played non-competitively. However, in other embodiments, a winner may be declared. For example, a player discarding the highest number of cards in the game may be declared the winner.

One or more aspects of the math game may be implemented using a computer. For example, the set of numbers for each turn may be generated using a random number generator. The random number generator may be an application on a smartphone or other computing device. In some embodiments, the math game is played in a virtual environment and the steps of the method are executed by a video game application on a computing device. Computing devices may include desktops, laptops, video game consoles, tablets and smartphones. The math game may be played in a virtual environment locally or online.

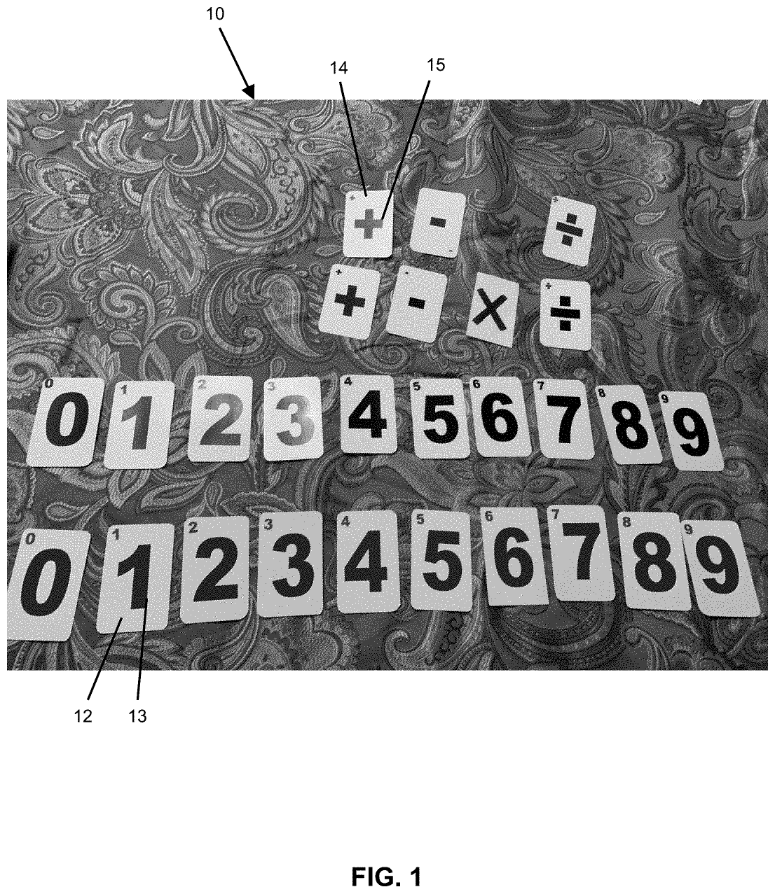

One example of a deck of cards 10 for playing a math game is provided in FIG. 1. The deck of cards 10 includes a first set of cards 12 each marked with a numerical operand 13 as indicia and a second set of cards 14 marked with an arithmetic operator 15 as indicia. During play, the first and second set of cards are to be shuffled together.

In some embodiments, each card from the first set of cards 12 may be marked with a single numerical operand ranging from 0 to 9. Numbers comprising two or more digits may be represented by two or more cards. For example, the number “35” may be the combination of a card marked with a “3” and a card marked with a “5”. In other embodiments, each card may be marked with a number comprising two or more digits.

In certain embodiments, the numerical operand may be marked with a fraction or a decimal number. For example, a card may be marked with the fraction “½”. In another example, a card may be marked with as “0.5”. In other embodiments, fractions and decimals may be formed using multiple cards by the user. For example, a user wishing to place the fraction “½” may combine a first card marked with a “1”, a second card marked with a “2” and a third card marked with a line to indicate that the “1” and “2” are to be read together as a fraction. In another example, a user wishing to place the decimal “0.5” may combine a first card marked with a “0”, a second card marked with a “5” and a third card marked with a period to indicate that the “0” and “5” are to be read together as a decimal.

The second set of cards 14 may be marked with various arithmetic operators. For example, each card may be marked with an addition operator, a subtraction operator, a multiplication operator or a division operator. In other embodiments, the arithmetic operator may be an exponent operator or a root operator. For example, the exponent operator may be marked on a card as “\hat{ }”. In other examples, the root operator may be a square root operator or a cube root operator.

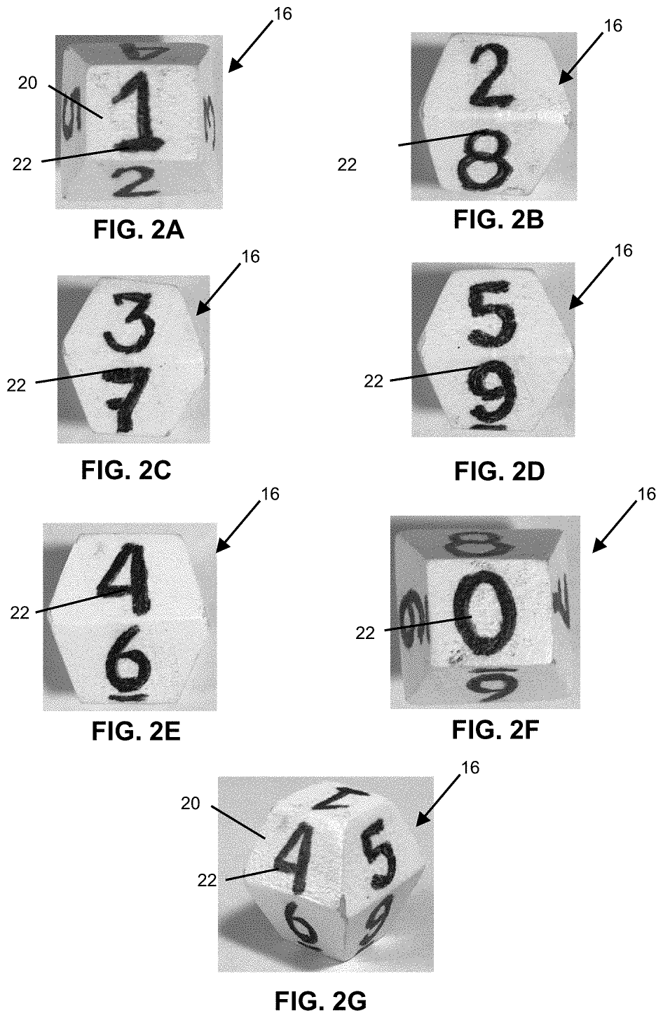

The math game may further include one or more dice 16. Each die 16 is labeled with a set of numbers. The shape of the die 16 may be a regular polyhedron or an irregular polyhedron. Irregular polyhedrons may be used in some embodiments to bias rolls of the die to certain numbers, whereas regular polyhedrons with each side labeled with a unique number may be used so that each number has an equal probability. However, certain embodiments of regular polyhedrons may have two or more faces labeled with the same number to bias the odds toward that particular number. In one embodiment, the die 16 may be a decahedron with ten faces as shown in FIG. 2A-2G. In the embodiment shown, each face 20 is labeled with a unique numerical digit 22 ranging from 0 to 9.

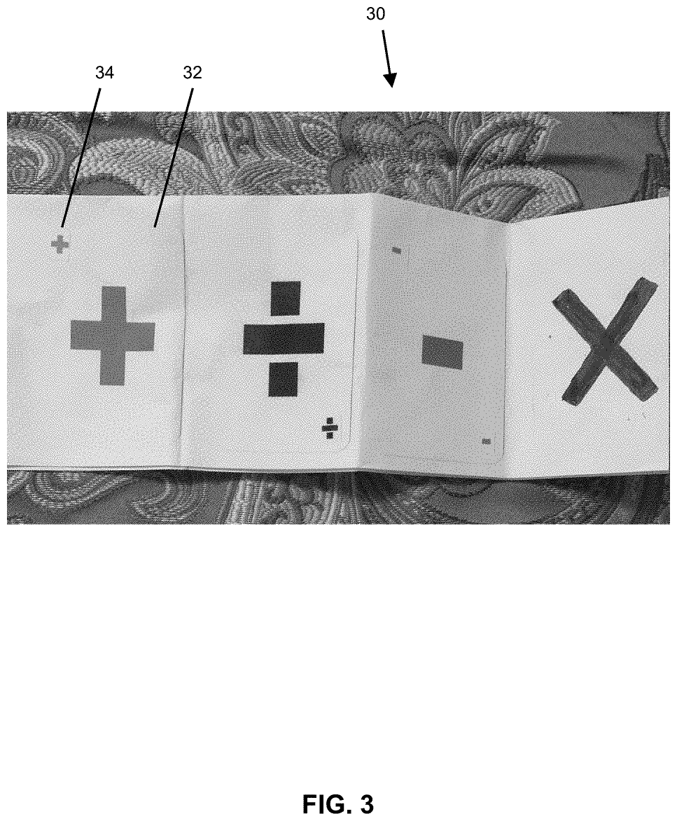

In some embodiments, the math game may further include a board 30 as shown in FIG. 3. The board 30 may comprise one or more surfaces 32 marked with a series of arithmetic operators 34. The surface 32 may be a single surface that is substantially flat. In some embodiments, the board 32 may comprise multiple surfaces 32 each having an arithmetic operator 34 assigned to a particular surface 32.

Although the present approach has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present approach.

We claim:

1. A method of playing a math game among n players comprising:
dealing each player a set of cards from a deck of cards, each card from the deck marked with either a numerical operand or an arithmetic operator as indicia,
alternating turns among the n players, each turn comprising rolling a set of dice to generate a set of numbers,
during each turn, each player discards one or more cards among the player's set of cards by placing the one or more cards onto a discard pile corresponding to an outcome of a mathematical operation performed on the set of numbers.

2. The method of claim 1, wherein the numerical operand marked on one of the cards discarded is a number equal to the outcome of the mathematical operation.

3. The method of claim 1, wherein two or more cards each containing numerical operands are combined by one of the players to read as a single number equal to the outcome of the mathematical operation.

4. The method of claim 1, wherein the discarded cards from a player's set is a combination of two or more cards with a numerical operand and one of the cards with an arithmetic operator, the combination of which forms a mathematical expression whose outcome is equal to the outcome of the mathematical operation performed on the set of numbers.

5. The method of claim 1, wherein the outcome comprises a sum, a difference, a product, or a quotient of the set of numbers.

6. The method of claim 1, wherein n is two or greater.

7. The method of claim 6 further including drawing another set of cards by one of the players when the player discards all cards dealt.

8. The method of claim 7 further including declaring the player discarding the highest number of cards as the winner.

9. The method of claim 8, wherein the winner is declared after all cards from the deck are discarded.

10. The method of claim 1, wherein each die comprises ten faces with each face assigned a unique numerical digit.

11. The method of claim 1, wherein the set of dice is equal to two.

12. The method of claim 1, wherein the cards with the arithmetic operator indicia are marked with one or more operators selected from the group comprising an addition operator, a subtraction operator, a multiplication operator and a division operator.

13. The method of claim 1, wherein the game is played in a virtual environment and the steps of the method are executed by a video game application on a computing device.

14. The method of claim 1, wherein n is equal to one.

15. A deck of playing cards comprising:
a first group of cards each having a numerical operand as indicia,
a second group of cards each having an arithmetic operator as indicia,
wherein the first group of cards and the second group of cards are shuffled together and three or more cards from a set of cards dealt from the deck are intended to be combined to form a mathematical expression.

16. The deck of playing cards of claim 15, wherein the cards with the arithmetic operator indicia are marked with one or more operators selected from the group comprising an addition operator, a subtraction operator, a multiplication operator and a division operator.

17. A math game comprising the deck of playing cards of claim 15 and one or more dice, wherein each die comprises ten faces with each face assigned a unique numerical digit.
